(19) United States
(12) Patent Application Publication
(10) Pub. No.: US 2026/0209969 A1
(43) Pub. Date: Jul. 23, 2026

(54) ALLOY CATALYST AND METHOD FOR PREPARING THE SAME

(71) Applicant: NATIONAL CHENG KUNG UNIVERSITY, Tainan City (TW)

(72) Inventors: Jyh-Ming TING, Tainan City (TW); Chia-Chi Hsu, Tainan City (TW)

(73) Assignee: NATIONAL CHENG KUNG UNIVERSITY, Tainan City (TW)

(21) Appl. No.: 19/086,347

(22) Filed: Mar. 21, 2025

(30) Foreign Application Priority Data
Jan. 22, 2025 (TW) 114102676

(51) Int. Cl. C25B 11/089; B22F 9/20; C22C 1/04; C22C 19/07; C22C 30/06

(52) U.S. Cl. CPC C25B 11/089; B22F 9/20; C22C 1/0433; C22C 19/07; C22C 30/06; B22F 2301/00; B22F 2301/15; B22F 2998/10; B22F 2999/00

(57) ABSTRACT

An alloy catalyst, comprising 0.01 wt % to 30.0 wt % of Zn, 50.0 wt % to 99.9 wt % of other metals, and 0.0 wt % to 20.0 wt % of noble metals, wherein the other metals comprise at least one metal selected from a group consisting of Ni, Fe, Mo, and Co. The alloy catalyst features a porous structure formed through dealloying. The alloy catalyst of the present disclosure exhibits low overpotential, low Tafel slope, and high stability.

### CROSS REFERENCE TO RELATED APPLICATIONS

This application claims the benefit of priority under 35 USC § 119(a) to Taiwanese Patent Application No. 114102676, filed on Jan. 22, 2025, the entire disclosure of which is incorporated herein by reference.

### FIELD OF TECHNOLOGY

The following relates to an alloy catalyst and a method for preparing the same, particularly to a noble metal-modified alloy catalyst for hydrogen production via water electrolysis and a method for preparing the same.

### BACKGROUND

Hydrogen production via water electrolysis has garnered widespread attention as a clean and sustainable energy source. The hydrogen evolution reaction (HER) is a key half-reaction in water electrolysis. To enhance the performance and economic feasibility of hydrogen production systems, highly efficient and cost-effective catalysts are crucial.

Noble metals, such as platinum, have demonstrated excellent catalytic activity for the hydrogen evolution reaction due to their superior hydrogen adsorption energy. However, the scarcity and high cost of platinum limit its widespread application in large-scale hydrogen production. Consequently, developing alternative catalysts that achieve performance comparable to platinum while reducing the overall noble metal content has become a major research focus.

Alloy-based catalysts have emerged as promising candidates for hydrogen evolution reaction applications. By combining different metal elements, the electronic structure and surface properties of the catalyst may be adjusted, potentially enhancing its catalytic activity and stability. Additionally, surface modification techniques, such as modifying the alloy surface with a small amount of noble metals, may reduce noble metal usage while further improving catalytic performance. This approach aims to combine the advantages of alloy-based catalysts with the superior catalytic properties of noble metals while minimizing the use of expensive materials.

However, developing highly active and stable catalysts for the hydrogen evolution reaction remains an ongoing challenge in the field of electrocatalysis. There is an urgent need for inventions that may optimize the composition, structure, and surface properties of catalysts to achieve improved performance and durability.

### SUMMARY

The development of highly efficient and cost-effective catalysts for the hydrogen evolution reaction still faces several challenges, such as:

First, reducing the reliance on expensive noble metals while maintaining high catalytic activity. The scarcity and high cost of platinum limit its widespread application in large-scale hydrogen production systems.

Second, the stability and durability of the catalyst under operating conditions are also important factors. Catalysts may degrade or lose activity over time, particularly under the harsh alkaline environments commonly encountered in water electrolysis.

Moreover, achieving high catalytic activity at low overpotential may be key to improving the overall efficiency of hydrogen production. Catalysts capable of driving the hydrogen evolution reaction at potentials close to the thermodynamic limit may help reduce energy input requirements.

Accordingly, in some cases, developing a catalyst having a porous structure with optimized pore size and distribution, as well as high surface area and abundant active sites, may enhance performance. Furthermore, by optimizing the electronic structure and bonding properties of the catalyst, its electronic structure may be modified to facilitate hydrogen adsorption and desorption, thereby contributing to improved overall system performance.

Accordingly, the present disclosure provides an alloy catalyst comprising zinc (Zn), other metals, and noble metals, wherein the other metals include at least one metal selected from a group consisting of nickel (Ni), iron (Fe), molybdenum (Mo), and cobalt (Co); wherein, relative to the alloy catalyst, the Zn content is from 0.01 wt % to 30.0 wt %, a total content of the other metals is from 50.0 wt % to 99.9 wt %, and the noble metal content is from 0.0 wt % to 20.0 wt %; wherein, the noble metals may be platinum (Pt), iridium (Ir), or palladium (Pd). The catalyst of the present disclosure achieves alloying and dealloying simultaneously through an annealing step, thereby exhibiting specific surface area structures and overpotentials and/or Tafel slopes within specific ranges.

The present disclosure also provides a method for preparing the alloy catalyst, comprising the following steps: (1) Synthesis of glycerates by a solvothermal method, (2) annealing treatment, and optionally (3) surface modification with noble metals. In step (2) of the annealing treatment, the present disclosure achieves alloying and dealloying simultaneously.

In one aspect, the present disclosure provides an alloy catalyst comprising 0.01 wt % to 30.0 wt %, or 0.10 wt % to 24.3 wt %, or 0.40 wt % to 15.0 wt %, or 0.50 wt % to 3.0 wt % of Zn; a total content of 50.0 wt % to 99.9 wt %, or 55.0 wt % to 95.0 wt %, or 60.0 wt % to 80.0 wt %, or 65.0 wt % to 75.0 wt % of other metals; and 0.0 wt % to 20.0 wt %, or 4.0 wt % to 16.0 wt %, or 5.0 wt % to 15.0 wt %, or 6.0 wt % to 12.0 wt % of noble metals. The noble metal may be platinum (Pt), iridium (Ir), or palladium (Pd), and the other metals include at least one metal selected from a group consisting of Ni, Fe, Mo, and Co; the alloy catalyst has a porous structure formed through alloying and dealloying achieved in a single annealing step.

Furthermore, the alloy catalyst of the present disclosure achieves both alloy formation and dealloying in a single step through an annealing process during preparation. Accordingly, the alloy is formed, and Zn is removed from the alloy during the annealing step. By controlling the content ratio range of the respective metals, the intrinsic activity and quantity of active sites may be enhanced. may

Preferably, the noble metal may be Pt. In one aspect, the noble metal may be Pt with a content of 4.0 wt % to 16.0 wt %.

In one aspect, the alloy catalyst is a binary alloy catalyst with a composition represented as ZnₐM_{b}N_{c}, wherein M is one selected from Ni, Fe, Mo, and Co, and N is a noble metal; wherein, a is from 0.01 wt % to 30.0 wt %, or 0.10 wt % to 24.3 wt %, or 0.40 wt % to 15.0 wt %, or 0.50 wt % to 3.0 wt %; b is from 50.0 wt % to 99.9 wt %, or 55.0 wt % to 95.0 wt %, or 60.0 wt % to 80.0 wt %, or 65.0 wt % to 75.0 wt %; and c is from 0.0 wt % to 20.0 wt %, or 4.0 wt % to 16.0 wt %, or 5.0 wt % to 15.0 wt %, or 6.0 wt % to 12.0 wt %. In one aspect, M is Ni or Co.

In one aspect, the alloy catalyst is a ternary alloy catalyst, the composition of the ternary alloy catalyst is ZnₐM1_{b1}M2_{b2}N_{c}, wherein M1 and M2 are each independently selected from one of Ni, Fe, Mo and Co, with M1 being different from M2; N is a noble metal; wherein, b1 is from 25.0 wt % to 50.4 wt %, and b2 is from 25.0 wt % to 50.4 wt %; a is from 0.01 wt % to 30.0 wt %, or 0.10 wt % to 24.3 wt %, or 0.40 wt % to 15.0 wt %, or 0.50 wt % to 3.0 wt %; and c is from 0.0 wt % to 20.0 wt %, or 4.0 wt % to 16.0 wt %, or 5.0 wt % to 15.0 wt %, or 6.0 wt % to 12.0 wt %. In one aspect, M1 may be Ni, and M2 may be Co.

In one aspect, the alloy catalyst is a quaternary alloy catalyst with a composition represented as ZnₐM1_{b1}M2_{b2}M3_{b3}N_{c}, wherein M1, M2, and M3 are each independently selected from one of Ni, Fe, Mo, and Co, with M1, M2, and M3 being different from one another; N is a noble metal; wherein, b1 is from 4.0 wt % to 50.4 wt %, b2 is from 4.0 wt % to 50.4 wt %, and b3 is from 4.0 wt % to 50.4 wt %; a is from 0.01 wt % to 30.0 wt %, or 0.10 wt % to 24.3 wt %, or 0.40 wt % to 15.0 wt %, or 0.50 wt % to 3.0 wt %; and c is from 0.0 wt % to 20.0 wt %, or 4.0 wt % to 16.0 wt %, or 5.0 wt % to 15.0 wt %, or 6.0 wt % to 12.0 wt %. In one aspect, M1 may be Ni, M2 may be Co, and M3 may be Fe or Mo.

In one aspect, the alloy catalyst is a quinary alloy catalyst with a composition represented as ZnₐM1_{b1}M2_{b2}M3_{b3}M4_{b4}N_{c}, wherein M1, M2, M3, and M4 are Ni, Fe, Mo, and Co, respectively, and N is a noble metal; wherein, b1 is from 4.0 wt % to 50.4 wt %, b2 is from 4.0 wt % to 50.4 wt %, b3 is from 4.0 wt % to 50.4 wt %, and b4 is from 4.0 wt % to 50.4 wt %; a is from 0.01 wt % to 30.0 wt %, or 0.10 wt % to 24.3 wt %, or 0.40 wt % to 15.0 wt %, or 0.50 wt % to 3.0 wt %; and c is from 0.0 wt % to 20.0 wt %, or 4.0 wt % to 16.0 wt %, or 5.0 wt % to 15.0 wt %, or 6.0 wt % to 12.0 wt %.

In another aspect, the present disclosure also provides a method for preparing an alloy catalyst, comprising:
Step 1: Mixing a zinc source and a metal precursor source in an isopropanol (IPA) and glycerol solution, followed by microwave-assisted solvothermal method heating, washing, and drying to obtain glycerate powder;
Step 2: Annealing the glycerate powder at a temperature of 350~600° C. and a pressure of 7×10⁻¹~760 torr to obtain alloy powder.

The present disclosure achieves alloying and dealloying simultaneously in the annealing step of Step 2, resulting in the prepared alloy catalyst exhibiting low overpotential, low Tafel slope, and high stability.

Preferably, the metal precursor source include at least one selected from a group consisting of nickel source, cobalt source, iron source, and molybdenum source. More preferably, the metal precursor source is selected from nickel source and cobalt source.

Preferably, the preparation method further comprises Step 3:
Step 3: Mixing the alloy powder with chloroplatinic acid in an ethylene glycol solution, followed by microwave-assisted solvothermal method heating, washing, filtering, and drying to obtain the alloy catalyst.

Preferably, the zinc source is zinc nitrate or a hydrate of zinc nitrate; the nickel source is nickel nitrate or a hydrate of nickel nitrate; the cobalt source is cobalt nitrate or a hydrate of cobalt nitrate; the iron source is iron nitrate or a hydrate of iron nitrate; and the molybdenum source is molybdenum pentachloride.

Furthermore, the metal precursors and their respective amounts may be as follows:
Zinc nitrate hexahydrate: 0.625 mmol
Nickel nitrate hexahydrate: 0.15625~0.3125 mmol
Cobalt nitrate hexahydrate: 0.15625~0.3125 mmol
Iron nitrate nonahydrate: 0.15625~0.2083 mmol
Molybdenum pentachloride: 0.15625~0.2083 mmol

Preferably, in Step 1, the zinc source and metal precursor source are mixed in an isopropanol (IPA) and glycerol solution, stirred at a speed of 600~800 rpm for 45 to 75 minutes, and more preferably stirred at approximately 700 rpm for about 1 hour.

Preferably, in Step 1, the volume ratio of IPA to glycerol in the mixture is 7:1 to 4:1, more preferably 6:1 to 5:1, and more preferably approximately 5.67:1.

Preferably, in Step 1, the conditions for the microwave-assisted solvothermal method involve heating at 130~180° C. for 20~40 minutes, more preferably at 140~180° C. for 25~35 minutes, and more preferably at approximately 150~180° C. for about 30 minutes.

Preferably, in Step 3, the conditions for the microwave-assisted solvothermal method involve heating at 130~180° C. for 10~30 minutes, more preferably at 140~180° C. for 10~20 minutes, and more preferably at approximately 150~180° C. for about 15 minutes.

Preferably, in Step 2, the annealing process is carried out at a temperature of 400~500° C.

The alloy catalyst and a method for preparing the same of the present disclosure, through the synergistic effects of the alloy composition and optional platinum modification, and the simultaneous achievement of alloying and dealloying in an annealing step, provide multiple inventive effects to improve the performance of the hydrogen evolution reaction:

In some aspects, through the synergistic effects of the alloy composition and platinum modification, as well as the simultaneous achievement of alloying and dealloying in an annealing step, the catalyst may exhibit higher catalytic activity, thereby enhancing hydrogen production efficiency while reducing the consumption of noble metals.

In some aspects, the porous structure formed through dealloying may provide a high surface area, thereby increasing the number of active sites available for the hydrogen evolution reaction, which may help improve catalytic performance and efficiency.

In some aspects, the catalyst may exhibit better stability and durability in alkaline environments, with the alloy composition and porous structure contributing to the maintenance of catalytic activity over long-term operation.

In some aspects, the catalyst may have a low overpotential value, reducing the energy requirements for hydrogen production and thereby improving the overall efficiency of the water electrolysis system.

In some aspects, the preparation method allows precise control over the composition and structure of the catalyst.

In some aspects, the catalyst may exhibit improved mass transport properties due to its porous structure. This characteristic may facilitate the rapid diffusion of reactants and products, further enhancing the reaction rate and efficiency.

In some aspects, the catalyst may have a low Tafel slope, indicating favorable reaction kinetics for the hydrogen evolution reaction. This characteristic may result in faster reaction rates and improved overall performance.

In some aspects, the catalyst may demonstrate high selectivity for the hydrogen evolution reaction, thereby improving the efficiency and purity of hydrogen production.

In some aspects, the microwave-assisted solvothermal method, surface modification, and the simultaneous achievement of alloying and dealloying in an annealing step, compared to conventional methods, may offer advantages in terms of reduced processing time and energy consumption. These advantages may facilitate a more efficient and cost-effective method for catalyst preparation.

### BRIEF DESCRIPTION

Some of the embodiments will be described in detail, with reference to the following figures, wherein like designations denote like members, wherein:

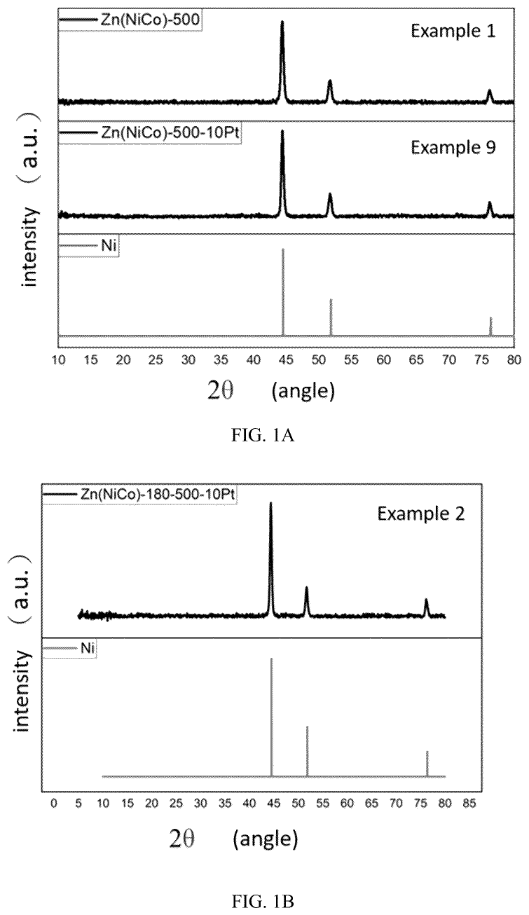

FIG. 1A shows the X-ray diffraction (XRD) analysis diagram of Examples 1 and 9.

FIG. 1B shows the X-ray diffraction (XRD) analysis diagram of Example 2.

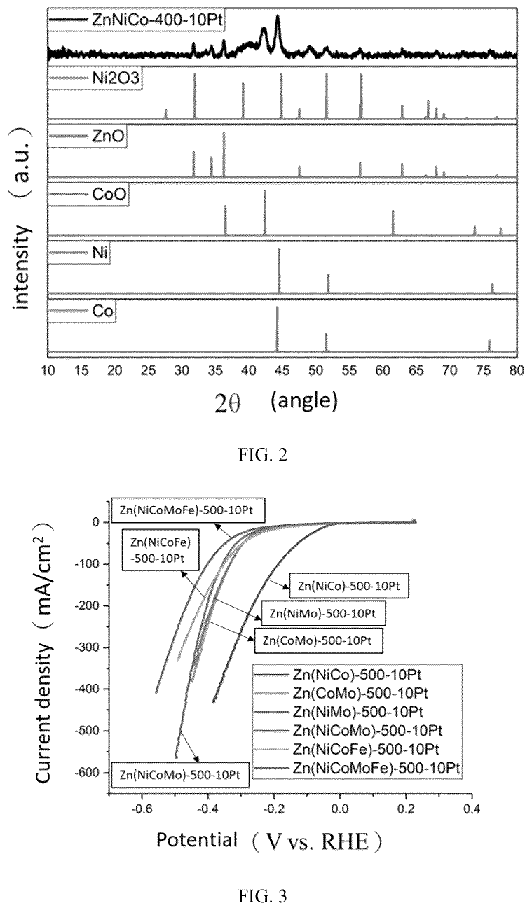

FIG. 2 shows the X-ray diffraction (XRD) analysis diagram of Example 3.

FIG. 3 shows the electrochemical performance analysis of different metal compositions in various examples under the annealing condition at 500° C.

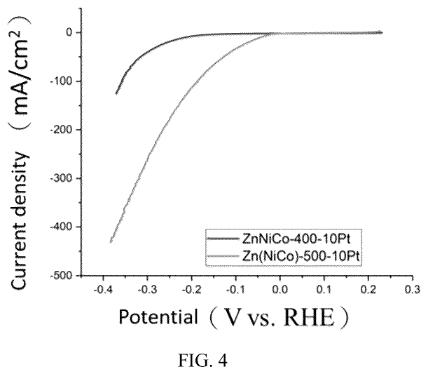

FIG. 4 shows the electrochemical performance of different metal compositions in Examples 2 and 3 under annealing conditions at 400° C. and 500° C.

### DETAILED DESCRIPTION

The following detailed description discloses exemplary embodiments and examples of the present disclosure. However, it should be understood that this description is not intended to limit the scope of the present disclosure; on the contrary, the present disclosure also encompasses combinations and modifications of the exemplary embodiments and examples described herein.

The present disclosure relates to an alloy catalyst that may be used for hydrogen production via water electrolysis. The present disclosure also provides a method for preparing a noble metal-modified alloy catalyst, which may include performing a microwave-assisted solvothermal method, annealing treatment, and surface modification with noble metals, and may utilize specific types of precursors, control the precursor ratios within designated ranges, and maintain process parameters (including the pressure and temperature ranges for the dealloying in the annealing step) within specified general and preferred ranges. Furthermore, the preparation method includes a single annealing step that simultaneously achieves alloy formation and dealloying. This method facilitates the formation of catalysts with enhanced stability and performance characteristics.

### [Composition of the Catalyst]

The composition of the catalyst may utilize zinc as a basic material. In some aspects, additional elements (e.g., nickel, iron, molybdenum, cobalt) may be introduced to form binary to quinary alloys. Through various combinations and proportions of these elements, the electronic structure and surface properties of the catalyst may be adjusted.

In some aspects, the zinc content in the catalyst may be adjusted, and the content of the other elements (Ni, Fe, Mo, and/or Co) may also be varied. The noble metal content may be adjusted to balance catalytic activity and cost considerations. By adjusting the composition and relative proportions of these elements, the electronic structure and surface properties of the catalyst may be optimized to enhance its performance in the hydrogen evolution reaction. Specific combinations and proportions of elements may influence factors such as bonding energy, electron transfer rates, and stability under reaction conditions.

The catalyst may provide a high-performance, long-term stable, and cost-effective solution, making it particularly suitable for large-scale hydrogen production systems and water electrolysis applications.

### [Preparation of the Catalyst]

In some aspects, the preparation of the catalyst may include solvothermal treatment to prepare precursor materials. The solvothermal treatment may employ a microwave-assisted solvothermal method to enhance reaction rates and product uniformity. The precursor materials used for solvothermal treatment may include multiple metal salts. In some cases, these metal salts may be nitrates, such as zinc nitrate hexahydrate, nickel nitrate hexahydrate, and cobalt nitrate hexahydrate. Other metal salts, such as iron nitrate nonahydrate or molybdenum pentachloride, may also be used in alternative aspects of the process.

The proportion of precursor materials may be adjusted based on the desired composition of the final catalyst. In some aspects, the molar ratios of the precursors may fall within specified ranges. For example, the content of zinc nitrate hexahydrate may range from approximately 0.5 to 0.75 mmol, while the content of nickel nitrate hexahydrate and cobalt nitrate hexahydrate may each range from approximately 0.15 to 0.35 mmol. If iron or molybdenum precursors are included, their content may range from approximately 0.15 to 0.25 mmol.

### [Microwave-Assisted Solvothermal Method]

The microwave-assisted solvothermal method may utilize mixed solvents. In some aspects, the solvent mixture may include isopropanol and glycerol. The volume ratio of isopropanol to glycerol may be adjusted, typically ranging from approximately 5:1 to 6:1. Precursor materials may be mixed with the solvent mixture and stirred to ensure thorough mixing. In some aspects, the stirring speed may range from approximately 600 to 700 rpm, with a duration of about 45 to 75 minutes. The mixed solution may then be subjected to microwave-assisted heating. The temperature and duration of this heating step may be controlled to optimize the formation of the precursor material. In some aspects, the solution may be heated to approximately 140 to 190° C., with a duration of about 25 to 35 minutes. After microwave heating, the resulting product may be washed and filtered to remove unreacted precursors or by-products. In some aspects, ethanol may be used as the washing agent, and multiple centrifugations may be performed to ensure thorough cleaning. The washed product may be filtered using filter paper with pore sizes of approximately 20 to 25 micrometers. The filtered product may then be dried to obtain the precursor material in powder form. In some aspects, drying may be conducted in a vacuum oven at a temperature of approximately 55 to 65° C., with a duration of about 20 to 28 hours. By controlling the type and proportion of precursor materials, as well as the parameters of the solvothermal treatment process, the composition and properties of the precursor material may be adjusted. This precursor material serves as the foundation for the catalyst preparation process, influencing the structure and performance of the final alloy catalyst.

### Annealing Step: Alloying and Dealloying

The preparation process of the catalyst may include a single annealing step that simultaneously achieves alloying and dealloying. This method offers advantages in terms of process efficiency and material stability. Annealing may be performed in a tube furnace under an argon/hydrogen atmosphere with a ratio of 180/20 sccm, using a heating rate of 5° C. per minute to precisely control the temperature and pressure conditions. The annealing temperature range may vary depending on the composition of the precursor materials and the desired properties of the final catalyst. In some aspects, the annealing temperature may range from approximately 350 to 550° C., and more preferably, within a range of approximately 400 to 500° C. The pressure inside the tube furnace may be controlled to facilitate the alloying and dealloying processes. In some aspects, the pressure may range from approximately 7×10⁻¹ to 760 torr. The duration of the annealing process may also be adjusted to optimize the degree of alloy formation and dealloying. In some aspects, the annealing step may last for approximately 1 to 4 hours, more specifically, around 2 hours. During the annealing process, multiple transformations may occur in the precursor materials. Metal salts may be reduced to their metallic forms, forming alloy structures. Simultaneously, dealloying may take place, where zinc is selectively removed, resulting in a porous structure with a high surface area. Annealing in a tube furnace may enhance the stability of the material. The controlled environment may prevent oxidation or contamination of the catalyst material during high-temperature treatment. Furthermore, vacuum conditions may promote the removal of volatile components, thereby forming a stable porous structure.

By achieving alloying and dealloying in a single annealing step, this process offers several potential advantages. This method may reduce the overall number of processing steps, thereby improving the efficiency and reproducibility of catalyst production. Additionally, the simultaneous occurrence of alloying and dealloying may result in unique structural features, further enhancing the catalytic performance of the material.

[Surface Modification with Noble Metals]

Surface modification may be performed using platinum (Pt), iridium (Ir), or palladium (Pd). In some embodiments, chloroplatinic acid hexahydrate may be used as the precursor for platinum modification. In some aspects, the amount of chloroplatinic acid hexahydrate used may range from approximately 0.01 to 0.03 mmol, and preferably, around 0.0169 mmol. The solvent system for the platinum modification process may comprise a mixture of ethylene glycol and deionized water. The volume ratio of ethylene glycol to deionized water may be adjusted to optimize the deposition of platinum on the catalyst surface. In some aspects, the volume ratio is approximately 3:1. For example, approximately 15 ml of ethylene glycol and about 5 ml of deionized water may be used. Before platinum modification, the alloy catalyst powder may be dispersed in the ethylene glycol solvent. This dispersion step may include ultrasonic treatment to ensure uniform distribution of the catalyst particles. The duration of ultrasonic treatment may range from approximately 20 to 40 minutes, and in some cases, around 30 minutes. After dispersing the catalyst powder, a chloroplatinic acid solution may be added to the mixture. The resulting mixture may undergo further ultrasonic treatment to promote uniform mixing. The duration of the second ultrasonic treatment may also range from approximately 20 to 40 minutes. The microwave-assisted solvothermal treatment for platinum modification may be conducted under controlled temperature and time conditions. In some aspects, the temperature may range from approximately 140 to 180° C., or around 150° C., with a duration of approximately 10 to 20 minutes, or around 15 minutes. After the microwave-assisted solvothermal treatment, the resulting product may be washed to remove unreacted precursors or by-products. Deionized water may be used as the washing agent, and the product may be filtered using filter paper with a pore size of approximately 20 to 25 micrometers. The washed and filtered product may be dried to obtain the final platinum-modified alloy catalyst. The drying process may be conducted in a vacuum oven. In some aspects, the drying temperature may be approximately 55 to 65° C., with a duration of about 20 to 28 hours.

By controlling the precursor ratios, solvent composition, and process parameters of the platinum modification step, the distribution and loading of platinum on the surface of the alloy catalyst may be optimized. This surface modification may enhance the catalytic activity and stability of the noble metal-modified alloy catalyst in the hydrogen evolution reaction.

The preparation of the alloy catalyst is carried out through multiple embodiments, followed by material characterization and analysis.

The alloy catalyst is synthesized through the following steps:
Step 1:
(1) Mix the precursor materials in 34 ml of isopropanol (IPA) and 6 ml of glycerol, stirring at 700 rpm for 1 hour.
(2) Heat the mixture using a microwave-assisted solvothermal method for 30 minutes to synthesize glycerates.
(3) Wash the product with ethanol, centrifuge it three times, filter it using 22-micron filter paper, and dry it in a vacuum oven at 60° C. for 1 day to obtain glycerate powder.
Step 2:
(1) Anneal the glycerate powder in a tube furnace under an argon/hydrogen atmosphere with a ratio of 180/20 sccm at 400~500° C., with a pressure of 7×10⁻¹ to 760 torr and a heating rate of 5° C. per minute, for 2 hours to obtain alloy powder.
Step 3:
(1) Disperse the alloy powder in 15 ml of ethylene glycol, subject it to ultrasonic treatment for 30 minutes, and then mix it with a chloroplatinic acid solution (deionized water: 5 ml). Continue ultrasonic treatment for another 30 minutes to ensure uniform mixing of the solution.
(2) Process the solution using a microwave-assisted solvothermal method at 150° C. for 15 minutes.
(3) Wash the product with deionized water, filter it using 22-micron filter paper, and dry it in a vacuum oven for 1 day to obtain the final product.

In the aforementioned steps, different experimental parameters were adjusted to obtain the alloy catalysts for the respective examples shown in Table 1 below:

TABLE 1

| | | Step 1 | Step 1 | | |
|---|---|---|---|---|---|
| | | Amount | Micro- | | |
| | | of each | wave- | | |
| | | metal | assisted | | |
| | | compo- | solvo- | Step 2 | |
| | | nent in | thermal | An- | Step 3 |
| | Alloy | the pre- | method | nealing | chloro- |
| | Catalyst | cursor | temper- | temper- | platinic |
| | Code | material | ature | ature | acid |
| Exam- | Zn(NiCo)- | Zn: | 150° C. | 500° C. | Step 3 |
| ple 1 | 500 | 0.625 | | | was not |
| | | mmole | | | performed. |
| | | Ni: | | | |
| | | 0.3125 | | | |
| | | mmole | | | |
| | | Co: | | | |
| | | 0.3125 | | | |
| | | mmole | | | |
| Exam- | ZnNiCo- | Zn: | 180° C. | 500° C. | chloroplatinic |
| ple 2 | 180-500- | 0.625 | | | acid |
| | 10Pt | mmole | | | hexahydrate: |
| | | Ni: | | | 0.0169 |
| | | 0.3125 | | | mmole |
| | | mmole | | | |
| | | Co: | | | |
| | | 0.3125 | | | |
| | | mmole | | | |
| Exam- | Zn(NiCo)- | Zn: | 150° C. | 400° C. | chloroplatinic |
| ple 3 | 400-10Pt | 0.625 | | | acid |
| | | mmole | | | hexahydrate: |
| | | Ni: | | | 0.0169 |
| | | 0.3125 | | | mmole |
| | | mmole | | | |
| | | Co: | | | |
| | | 0.3125 | | | |
| | | mmole | | | |
| Exam- | Zn(CoMo)- | Zn: | 150° C. | 500° C. | chloroplatinic |
| ple 4 | 500-10Pt | 0.625 | | | acid |
| | | mmole | | | hexahydrate: |
| | | Co: | | | 0.0169 |
| | | 0.3125 | | | mmole |
| | | mmole | | | |
| | | Mo: | | | |
| | | 0.3125 | | | |
| | | mmole | | | |
| Exam- | Zn(NiMo)- | Zn: | 150° C. | 500° C. | chloroplatinic |
| ple 5 | 500-10Pt | 0.625 | | | acid |
| | | mmole | | | hexahydrate: |
| | | Ni: | | | 0.0169 |
| | | 0.3125 | | | mmole |
| | | mmole | | | |
| | | Mo: | | | |
| | | 0.3125 | | | |
| | | mmole | | | |
| Exam- | Zn(NiCoMo)- | Zn: | 150° C. | 500° C. | chloroplatinic |
| ple 6 | 500-10Pt | 0.625 | | | acid |
| | | mmole | | | hexahydrate: |
| | | Ni: | | | 0.0169 |
| | | 0.2083 | | | mmole |
| | | mmole | | | |
| | | Co: | | | |
| | | 0.2083 | | | |
| | | mmole | | | |
| | | Mo: | | | |
| | | 0.2083 | | | |
| | | mmole | | | |
| Exam- | Zn(NiCoFe)- | Zn: | 150° C. | 500° C. | chloroplatinic |
| ple 7 | 500-10Pt | 0.625 | | | acid |
| | | mmole | | | hexahydrate: |
| | | Ni: | | | 0.0169 |
| | | 0.2083 | | | mmole |
| | | mmole | | | |
| | | Co: | | | |
| | | 0.2083 | | | |
| | | mmole | | | |
| | | Fe: | | | |
| | | 0.2083 | | | |
| | | mmole | | | |
| Exam- | Zn(NiCoMo | Zn: | 150° C. | 500° C. | chloroplatinic |
| ple 8 | Fe)-500-10Pt | 0.625 | | | acid |
| | | mmole | | | hexahydrate: |
| | | Ni: | | | 0.0169 |
| | | 0.1563 | | | mmole |
| | | mmole | | | |
| | | Co: | | | |
| | | 0.1563 | | | |
| | | mmole | | | |
| | | Mo: | | | |
| | | 0.1563 | | | |
| | | mmole | | | |
| | | Fe: | | | |
| | | 0.1563 | | | |
| | | mmole | | | |
| Exam- | ZnNiCo-500- | Zn: | 150° C. | 500° C. | chloroplatinic |
| ple 9 | 10Pt | 0.625 | | | acid |
| | | mmole | | | hexahydrate: |
| | | Ni: | | | 0.0169 |
| | | 0.3125 | | | mmole |
| | | mmole | | | |
| | | Co: | | | |
| | | 0.3125 | | | |
| | | mmole | | | |

The instruments and methods used for characterization are as follows:

Inductively Coupled Plasma-Mass Spectrometer (ICP-MS, THERMO-ELEMENT XR) for measuring the composition ratio of metal elements in the alloy catalyst.

X-ray diffractometer (XRD, D8 DISCOVER with GADDS, Bruker AXS Gmbh, Karlsruhe, Germany) for analyzing the crystal structure of the alloy catalyst.

X-ray photoelectron spectrometer (XPS/ESCA, PHI 5000 VersaProbe) for analyzing the electronic structure interactions between different metal elements.

Autolab electrochemical analyzer (Muti Autolab M204) for electrochemical performance analysis, with an electrochemical impedance spectrometer (EIS) and a current booster (Booster) to investigate the performance of the alloy catalyst. All experimental setups and data collection were controlled by NOVA electrochemical analysis software. A typical three-electrode system was utilized, which included:
The synthesized alloy catalyst as the working electrode (WE).
A graphite carbon rod as the counter electrode (CE).
An Hg/HgO as the reference electrode (RE).

The potential and current density variations were measured in a 1 M KOH electrolyte. The polarization curve was plotted using linear sweep voltammetry (LSV) in a single direction, with a scan rate of 5 mV/s. For comparison purposes, the potential of the reference electrode was corrected using the formula for the reversible hydrogen electrode (ERHE):

$${E}_{RHE} = {E}_{Hg / HgO} + 0.059 \times pH + 0.098$$

The pH value was measured using a pH meter (SUNTEX SP-2100), and the value was approximately 14. All polarization curves were corrected using 90% iR compensation.

Electrochemical Impedance Spectroscopy (EIS) Measurement: EIS measurements were conducted at an AC potential of −1.25 V, with a frequency range from 0.5 Hz to 4000 Hz. The alternating current obtained from the measurements was processed mathematically, combined with an equivalent circuit model to derive impedance parameters, including solution resistance (Rs) and charge transfer resistance (Rct).

First, the samples of Examples 1 to 3 were analyzed using an inductively coupled plasma mass spectrometer (hereinafter referred to as “ICP analysis”), and the results are shown in Tables 2 to 4 respectively:

TABLE 2
ICP analysis results of Example 1

| Zn(NiCo)-500 | wt% |
|---|---|
| Co | 50.4% |
| Ni | 49.0% |
| Zn | 0.6% |

TABLE 3
ICP analysis results of Example 2

| ZnNiCo-180-500-10Pt | wt% |
|---|---|
| Co | 45.0% |
| Ni | 44.9% |
| Pt | 9.2% |
| Zn | 0.9% |

TABLE 4
ICP analysis results of Example 3

| ZnNiCo-400-10Pt | wt% |
|---|---|
| Co | 32.1% |
| Ni | 32.0% |
| Pt | 11.6% |
| Zn | 24.3% |

Based on the ICP results, it may be observed that Zn was removed from the alloy, and under the annealing conditions of 500° C., almost all Zn was removed.

Subsequently, XPS analysis was performed for Examples 1 to 3, with the results as follows:

TABLE 5
XPS analysis results of Example 1

| Zn(NiCo)- | Zn2p3/2 | | Zn2p1/2 | | Ni2p3/2 | | Ni2p1/2 | | Co2p3/2 | |
|---|---|---|---|---|---|---|---|---|---|---|
| 500 | Zn(2+) | Zn(0) | Zn(2+) | Zn(0) | Ni(2+) | Ni(0) | Ni(2+) | Ni(0) | Co(2+) | Co(0) |
| Area | 100.0% | 0.0% | 100.0% | 0.0% | 82.7% | 17.3% | 82.2% | 17.8% | 63.6% | 36.4% |
| ratio | | | | | | | | | | |
| Position | 1021.8 | | 1044.7 | | 855.3 | 852.9 | 873.0 | 870.3 | 781.1 | 778.8 |
| | | Zn(NiCo)- | Co2p1/2 | | C1s | | | O1s | | |
| | | 500 | Co(2+) | Co(0) | C—C | C—O | O—C═O | M—O | M—OH | O—C═0 |
| | | Area | 70.4% | 29.6% | 48.1% | 23.7% | 25.6% | 28.7% | 44.8% | 26.6% |
| | | ratio | | | | | | | | |
| | | Position | 797.3 | 795.0 | 284.8 | 285.8 | 289.4 | 529.8 | 531.5 | 532.8 |

TABLE 6
XPS analysis results of Example 2

| Zn(NiCo)- | | | | | | | | | | | | |
|---|---|---|---|---|---|---|---|---|---|---|---|---|
| 180-500- | Zn2p3/2 | | Zn2p1/2 | | Ni2p3/2 | | Ni2p1/2 | | Co2p3/2 | | Co2p1/2 | |
| 10Pt | Zn(2+) | Zn(0) | Zn(2+) | Zn(0) | Ni(2+) | Ni(0) | Ni(2+) | Ni(0) | Co(2+) | Co(0) | Co(2+) | Co(0) |
| Area ratio | 100.0% | 0.0% | 100.0% | 0.0% | 96.2% | 3.8% | 97.6% | 2.4% | 100.0% | 0.0% | 100.0% | 0.0% |
| Position | 1021.9 | | 1044.9 | | 856.0 | 853.0 | 873.5 | 870.0 | 781.2 | | 797.1 | |
| | | Zn(NiCo)- | | | | | | | | | | |
| | | 180-500- | C1s | | | O1s | | | Pt4t7/2 | | Pt4t5/2 | |
| | | 10Pt | C—C | C—O | O—C═O | M—O | M—OH | O—C═O | Pt(2+) | Pt(0) | Pt(2+) | Pt(0) |
| | | Area ratio | 58.7% | 10.8% | 30.5% | 2.9% | 84.5% | 12.6% | 35.7% | 64.3% | 39.6% | 60.4% |
| | | Position | 284.8 | 285.7 | 288.8 | 529.6 | 531.6 | 533.6 | 72.4 | 71.5 | 75.5 | 74.8 |

TABLE 7
XPS analysis results of Example 3

| Zn(NiCo)- | Zn2p3/2 | | Zn2p1/2 | | Ni2p3/2 | | Ni2p1/2 | | Co2p3/2 | | Co2p1/2 | |
|---|---|---|---|---|---|---|---|---|---|---|---|---|
| 400-10Pt | Zn(2+) | Zn(0) | Zn(2+) | Zn(0) | Ni(2+) | Ni(0) | Ni(2+) | Ni(0) | Co(2+) | Co(0) | Co(2+) | Co(0) |
| Area ratio | 100.0% | 0.0% | 100.0% | 0.0% | 53.3% | 46.7% | 51.8% | 47.1% | 82.4% | 17.6% | 80.0% | 20.0% |
| Position | 1021.6 | | 1044.7 | | 854.9 | 852.6 | 873.5 | 870.0 | 780.3 | 778.1 | 796.1 | 793.1 |
| | | Zn(NiCo)- | C1s | | | O1s | | | Pt4t7/2 | | Pt4t5/2 | |
| | | 400-10Pt | C—C | C—O | O—C═O | M—O | M—OH | O—C═O | Pt(2+) | Pt(0) | Pt(2+) | Pt(0) |
| | | Area ratio | 64.1% | 21.9% | 14.0% | 25.1% | 64.2% | 10.7% | 34.3% | 65.7% | 31.3% | 68.7% |
| | | Position | 284.7 | 285.4 | 289.0 | 530.0 | 531.7 | 533.3 | 72.1 | 71.2 | 75.5 | 74.5 |

Subsequently, XRD analysis was conducted for Examples 1, 9, Example 2, and Example 3. The results are shown in FIG. 1A, FIG. 1B, and FIG. 2, respectively.

Next, the electrochemical performance differences of different metal compositions of each example under the annealing conditions of 500° C. were compared using overpotential, Rct, and Tafel slope. The results are shown in FIG. 3 and the following Table 8:

TABLE 8

| Alloy Catalyst | | | | |
|---|---|---|---|---|
| Code | Rct | η10 | η100 | Tafel |
| Zn(NiCo)-500-10Pt | 0.583 | −44.4 | −187.5 | 52 |
| Zn(CoMo)-500-10Pt | 1.692 | −189.7 | −333.2 | 162 |
| Zn(NiMo)-500-10Pt | 1.576 | −201.6 | −334.0 | 132 |
| Zn(NiCoMo)-500- | 1.221 | −174.7 | −355.3 | 171 |
| 10Pt | | | | |
| Zn(NiCoFe)-500- | 1.628 | −147.4 | −352.1 | 200 |
| 10Pt | | | | |
| Zn(NiCoMoFe)- | 3.400 | −214.8 | −402.2 | 241 |
| 500-10Pt | | | | |

Similarly, the electrochemical performance differences of different metal compositions of Examples 9 and 3 under the annealing conditions of 400° C. and 500° C. were compared using overpotential, Rct, and Tafel slope. The results are shown in FIG. 4 and the following Table 9:

TABLE 9

| Alloy Catalyst Code | Rct | η10 | η100 | Tafel |
|---|---|---|---|---|
| Zn(NiCo)-500-10Pt | 0.583 | −44.4 | −187.5 | 52 |
| ZnNiCo-400-10Pt | 2.558 | −214.1 | −356.3 | 127 |

The electrochemical results of Example 9 are further analyzed as follows:

TABLE 10
Further analysis of electrochemical results of Example 9

| Alloy | | | | | | |
|---|---|---|---|---|---|---|
| Catalyst | | | | | | |
| Code | Rct | η10 | η100 | η300 | η400 | Tafel |
| Zn(NiCo)- | 0.583 | −44.4 | −187.5 | −307.7 | −368.0 | 52 |
| 500-10Pt | | | | | | |

In summary, the alloy catalyst and method for preparing the same of the present disclosure, through the synergistic effects of alloy composition and platinum modification, as well as the simultaneous achievement of alloying and dealloying in a single annealing step, may achieve low overpotential values, reduce energy requirements for hydrogen production, and thereby enhance the overall efficiency of the water electrolysis system.

The terms used in the specification of the present disclosure are only used for the purpose of describing specific embodiments and are not intended to limit the present disclosure. As used in the present disclosure, the singular forms “a”, “an” and “the” do not imply a numerical limitation and should be interpreted to include both singular and plural forms unless the context explicitly indicates otherwise.

All ranges disclosed in the present disclosure include their endpoints, and combinations of endpoints within the ranges are considered independently. The terms “greater than” and “less than” include the respective numerical values themselves. The term “combinations thereof” includes one or more of the listed elements and is open-ended. It should also be understood that, as used in this specification, the term “comprising” specifies the presence of the stated characteristics, features, steps, elements, and/or components, but does not exclude the presence or addition of one or more other characteristics, features, steps, elements, components, and/or combinations thereof.

The terms “aspect” or “embodiment” refer to the associated description of the aspect or embodiment may be included in at least one aspect or embodiment of the present disclosure, and may or may not be present in other aspects or embodiments.

While preferred embodiments have been described, it should be understood that various modifications and improvements falling within the scope of the appended claims may now and in the future be made by those having ordinary skill in the art to which the present disclosure pertains. The claims should be interpreted to ensure appropriate protection for the subject matter disclosed for the first time.

What is claimed is:

1. An alloy catalyst comprising 0.01 wt % to 30.0 wt % of Zn, 50.0 wt % to 99.9 wt % of other metals, and 0.0 wt % to 20.0 wt % of a noble metal, wherein the other metals include at least one metal selected from a group consisting of Ni, Fe, Mo, and Co, and the noble metal is Pt, Ir, or Pd; wherein the alloy catalyst has a porous structure formed through alloying and dealloying achieved in a single annealing step.

2. The alloy catalyst according to claim 1, wherein the noble metal is Pt.

3. The alloy catalyst according to claim 1, wherein the alloy catalyst comprises 0.01 wt % to 30.0 wt % of Zn, 50.0 wt % to 99.9 wt % of a metal M, and 0.0 wt % to 20.0 wt % of the noble metal, wherein the metal M is Ni, Fe, Mo, or Co.

4. The alloy catalyst according to claim 1, wherein the alloy catalyst comprises 0.01 wt % to 30.0 wt % of Zn, 25.0 wt % to 50.4 wt % of a first metal M1, 25.0 wt % to 50.4 wt % of a second metal M2, and 0.0 wt % to 20.0 wt % of the noble metal, wherein the first metal M1 and the second metal M2 are each Ni, Fe, Mo, or Co, and the first metal M1 and the second metal M2 are different.

5. The alloy catalyst according to claim 1, wherein the alloy catalyst comprises 0.01 wt % to 30.0 wt % of Zn, 4.0 wt % to 50.4 wt % of a first metal M1, 4.0 wt % to 50.4 wt % of a second metal M2, 4.0 wt % to 50.4 wt % of a third metal M3, and 0.0 wt % to 20.0 wt % of the noble metal, wherein the first metal M1, the second metal M2, and the third metal M3 are each Ni, Fe, Mo, or Co, and the first metal M1, the second metal M2, and the third metal M3 are different from one another.

6. The alloy catalyst according to claim 1, wherein the alloy catalyst comprises 0.01 wt % to 30.0 wt % of Zn, 4.0 wt % to 50.4 wt % of Ni, 4.0 wt % to 50.4 wt % of Fe, 4.0 wt % to 50.4 wt % of Mo, 4.0 wt % to 50.4 wt % of Co, and 0.0 wt % to 20.0 wt % of the noble metal.

7. A method for preparing the alloy catalyst according to claim 1, comprising:
Step 1: Mixing a zinc source and a metal precursor source in an isopropanol and glycerol solution, followed by microwave-assisted solvothermal heating, washing, and drying to obtain glycerate powder;
Step 2: Annealing the glycerate powder at a temperature of 350~600° C. and a pressure of 7×10⁻¹~760 torr to obtain alloy powder;
wherein the metal precursor source includes at least one selected from a group consisting of nickel source, cobalt source, iron source, and molybdenum sources;
wherein the annealing in Step 2 achieves both alloying and dealloying.

8. The method for preparing the alloy catalyst according to claim 7, wherein:
the zinc source is zinc nitrate or a hydrate of zinc nitrate;
the nickel source is nickel nitrate or a hydrate of nickel nitrate;
the cobalt source is cobalt nitrate or a hydrate of cobalt nitrate;
the iron source is iron nitrate or a hydrate of iron nitrate; and
the molybdenum source is molybdenum pentachloride.

9. The method for preparing the alloy catalyst according to claim 7, further comprising:
Step 3: Mixing the alloy powder with chloroplatinic acid in an ethylene glycol solution, followed by microwave-assisted solvothermal heating, washing, filtering, and drying to obtain the alloy catalyst.

10. The method for preparing the alloy catalyst according to claim 7, wherein the microwave-assisted solvothermal heating in the Step 1 involve heating at 130~180° C. for 20~40 minutes.
